(19) United States
(12) Patent Application Publication
(10) Pub. No.: US 2004/0005205 A1
(43) Pub. Date: Jan. 8, 2004

(54) Cage nut with inverted cage

(76) Inventors: Donald L. Yake, Bluffton, IN (US); Steven Crowther, Leonard, MI (US); Rex Miller, Waterford, MI (US)

Correspondence Address: HARNESS, DICKEY & PIERCE, P.L.C., P.O. BOX 828, BLOOMFIELD HILLS, MI, 48303, US

(21) Appl. No.: 10/426,305

(22) Filed: Apr. 30, 2003

Related U.S. Application Data
(60) Provisional application No. 60/377,075, filed on Apr. 30, 2002.

(51) Int. Cl. F16B 39/284

(52) U.S. Cl. 411/112

(57) ABSTRACT

A cage nut assembly is disclosed having a body defining a through bore. The cage is disposed about at least a portion of the body. The body is hexagonal in shape, while the cage defines a seam configured to be placed adjacent the coupling surface of the cage and base material.

### CROSS-REFERENCE TO RELATED APPLICATIONS

This application claims the benefit of U.S. Provisional Application No. 60/377,075, filed on Apr. 30, 2002. The disclosure of the above application is incorporated herein by reference.

### FIELD OF THE INVENTION

The present invention relates to an encaged threaded fastener, and, more particularly, to an encaged fastener which minimizes problems of cage deformation caused by miss-insertion of a threaded member into the fastener.

### BACKGROUND OF THE INVENTION

With ever increasing design demands, flexibility and adaptivity of unibody construction is increasingly required in order to provide vehicles that meet broader customer needs. Increases in the number of components and structures which are coupled to the unibody construction have led designers to consistently add threaded fasteners to the unibody frame. Variation in manufacturing tolerances require that the fastener couple to the unibody frame in a way which allows a degree of positional adjustment during final assembly. This positional adjustment is provided by using a female fastener which is an encaged fastener. Typically, this takes the form of a nut encaged in a structure that is attached to the inner body frame. The cage is configured so as to provide the nut with a range of movement so that when a component is coupled to the frame, the alignment of the component and frame can be adjusted until they meet manufacturing standards.

Prior to final coupling of the components to the frame, however, significant rotational forces apply forces to the cage. To date, the step of rotating a fastener into the nut will often cause the fastener to bend the cage. This causes a significant amount of rework of the fastener joint and, therefore, causes manufacturing problems in the final assembly of the product. To prevent the manufacturing problems, post-process rework is often required to ensure that the fasteners can be properly coupled with an appropriate strength.

### SUMMARY OF THE INVENTION

Accordingly, this invention provides a cage nut fastener which is weldable to a substructure that overcomes the problems and disadvantages of the cage nuts of the prior art. Briefly, the invention includes a threaded fastener having a hexagonal head; a fastener cage capable of fastening the fastener to a substructure, the cage being formed so as to have a seam adjacent the substructure.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The greatest advantage of the present invention will become apparent to one skilled in the art upon reading the following specification and by reference to the drawings in which:

FIG. 1 is a perspective view of the cage nut fastener in its assembled condition;

FIG. 2 is a perspective view of the nut and base plate of the present invention;

FIG. 3 is a perspective view of the cage in FIG. 1; and

FIGS. 4a-4c represent top, side, and end views of the cage shown in FIG. 3.

### DETAILED DESCRIPTION OF THE PREFERRED EMBODIMENTS

The following description of the preferred embodiment(s) is merely exemplary in nature and is in no way intended to limit the invention, its application, or uses.

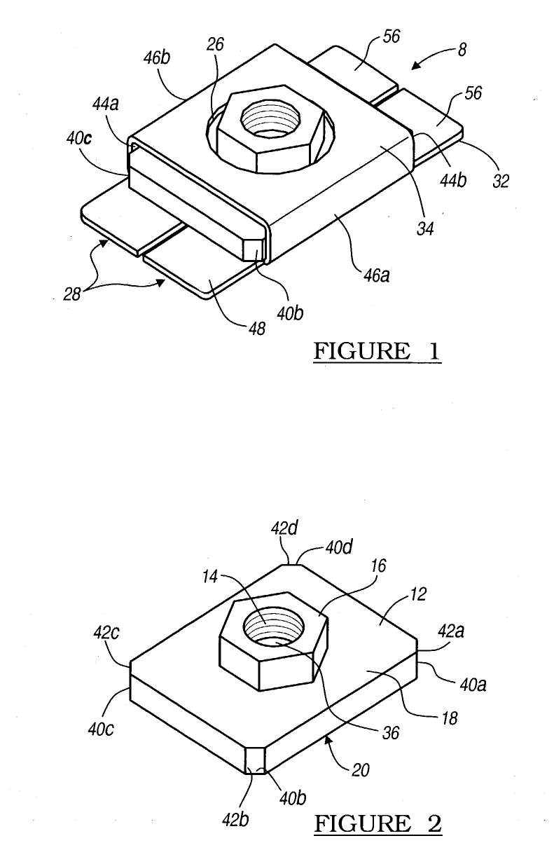

With reference to FIGS. 1-3, a cage nut fastener, shown generally at 8, has a hexagonal body 16 coupled to a planar base 12. The body 16 and planar base 12 define a threaded through bore 14. Planar base 12 has an upper base surface 18 and lower base surface 20. The cage nut assembly 8 further has a cage 22 which is generally disposed about the planar base 12. The cage 22 has a cage upper surface 34 and cage lower surface 32. The cage 22 lower surface is defined by a pair of co-planar flanges 28. The upper surface 34 defines a through hole 26 which generally corresponds to the shape of the hexagonal body 16.

As best seen in FIG. 2, the hexagonal body 16 takes the form of a hex nut 35 coupled to the planar base 12. The planar base 12 defines a hole 36 which is co-axial to the threaded through bore 14 of the hex nut 35. It is preferred that the hex nut 35 be of a type 10 hex nut or other suitable size defined by the needed configuration. Also, it is preferred that the hex nut 35 be of sufficient hardness through either heat treatment or metallurgy to ensure the proper coupling to the mating bolt (not shown).

As seen in FIG. 2, each corner 40a-d of the planar base 12 has a defined flats 42a-d which function as a load bearing surfaces to apply distributed loads to an interior surface 44a and 44b of the depending sidewalls 46a and 46b of the cage 22 when a bolt is inserted.

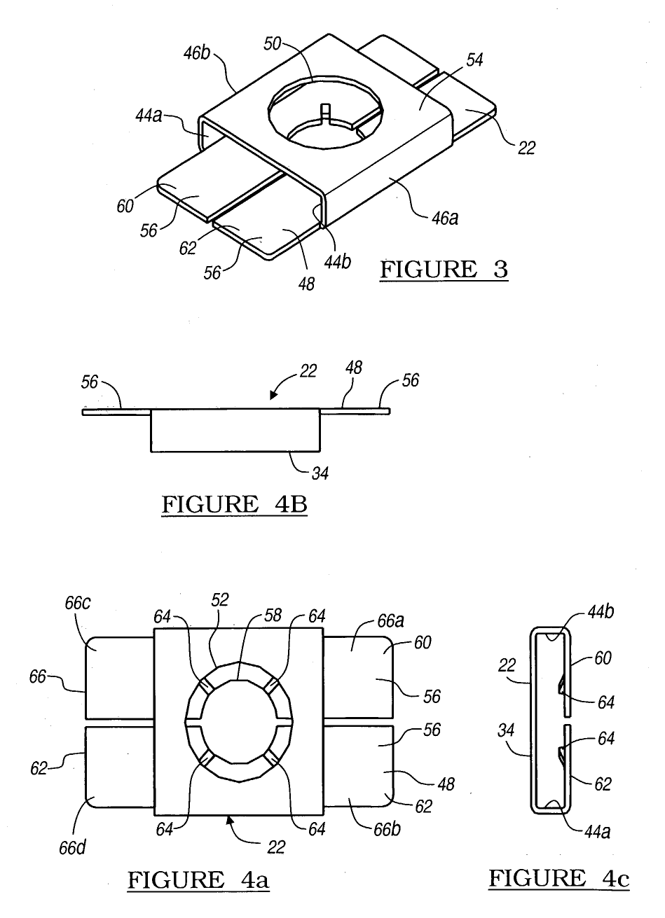

As best seen in FIGS. 3 through 4c, the cage 22 is formed of a single folded piece of sheet metal 48. The cage 22 has a through hole 50 which has a diameter larger than the diameter of the hex nut 38. The side 52 of the hole 50 limits the travel of the hex nut 35 within the cage 22.

The pair of depending sidewalls 46a and 46b of the cage 22 functions to couple the top member 54 of the cage 22 to the weldable lower members 56. Additionally, the depending sidewalls 46a and 46b absorb torsional energy imparted onto the cage 22 by the corners 40a-d of the base 12. The height of the cage 22 minimizes the movement of the base 12 away from the lower members 56 and further allows the hex nut 35 to rotate to ensure proper alignment upon driving of the coupling threaded fastener (not shown).

As seen in FIG. 4a, the lower members 56 define a through hole 58 which is co-axial to the passage of the hex nut 35 and the planar base 12. Additionally formed on the two sides 60 and 62 defining the lower members 56 are a number of upturned tabs 64 which raise the base 12 above the lower members 56 to prevent adhesion during painting applications. Additionally defined on the lower members 56 are four weldment pad areas 66a-d which provide the area to allow welding of the cage to the base substrate material. Defined generally equidistant between the two sides 60 and 62 is a seam, formed when the cage is wrapped around the base 12.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A cage nut comprising:
a fastener having a body coupled to a base; and
a cage adapted to enclose a portion of the fastener, said cage being adapted to be welded to a surface and wherein said cage defines a seam disposed between said body and said surface.

2. The cage nut assembly in accordance with claim 1, wherein the base is planar and wherein the cage defines a pair of flanges which enclose at least a portion of the base.

3. The cage nut assembly in accordance with claim 1, wherein the body has at least six surfaces and is coupled to a planar base, the body and planar base define a threaded through bore.

4. The cage nut assembly in accordance with claim 3, wherein the cage defines a through hole which generally co-axial with the through bore.

5. The cage nut assembly in accordance with claim 1, wherein the cage defines a pair of co-planar welding flanges.

6. The cage nut assembly in accordance with claim 1, wherein the cage has a pair of depending sidewalls which function to couple a cage top member to a pair of weldable lower members.

7. A floating fastener comprising:
a hexagonal body coupled to a base; and
a cage adapted to enclose the base and being adapted to be welded to a surface, said cage defines a seam disposed between said body and said surface, wherein the cage has a pair of depending sidewalls which function to couple a cage top member to a pair of weldable lower members.

8. The floating fastener assembly in accordance with claim 7, wherein the base is planar and wherein the cage defines a pair of flanges which cover at least a portion of the base.

9. The floating fastener assembly in accordance with claim 7, wherein the hexagonal body and planar base define a threaded through bore.

10. The floating fastener assembly in accordance with claim 7, wherein the cage defines a through hole which has a diameter larger than the diameter of the hexagonal body.

11. The floating fastener assembly in accordance with claim 7, wherein the pair of weldable lower members are co-planar.

12. The floating fastener assembly in accordance with claim 7, wherein the base defines a plurality of corners, each corner defining flats which are configured to function as a load bearing surfaces to apply and distributed loads to an interior surface of the depending sidewalls of the cage.

13. A floating fastener adapted to be welded to a surface comprising:
a body coupled to a planar base; and
a cage adapted to enclose the body, wherein the cage has a pair of depending sidewalls which function to couple a cage top member to a plurality of weldable lower members, the weldable lower members defining a seam disposed between said body and the surface.

14. The floating fastener assembly in accordance with claim 13, wherein the seam is disposed generally equidistant between the depending side walls.

15. The floating fastener assembly in accordance with claim 13, wherein the weldable lower members define a plurality of weldment pad areas which are configured to allow welding of the cage to the surface such that the seam is disposed between at least two weldment pad areas.

16. The floating fastener assembly in accordance with claim 13, wherein the weldable lower members define a number of upturned tabs which are configured to raise the base above the lower members to prevent adhesion during painting applications.

17. The floating fastener assembly in accordance with claim 13, wherein the cage is wrapped around the planar base.

18. The floating fastener assembly in accordance with claim 13, wherein the cage top member defines a through hole which has a diameter larger than a diameter of the body.

19. The floating fastener assembly in accordance with claim 13, wherein the planar base defines a hole which is co-axial to a threaded bore defined by the body.

20. The floating fastener assembly in accordance with claim 13, wherein the weldable lower members define an aperture which is co-axial to a threaded bore defined by the body and wherein the seam is defined through the aperture.

21. A fastener assembly adapted to be coupled to a surface comprising:
a threaded fastener;
a cage adapted to enclose the fastener, the cage defining a seam and a plurality of weldment locations, wherein the weldment locations are configured to prevent the opening of the seam upon application of a torque to the fastener.

22. The fastener assembly according to claim 21 wherein the seam is disposed between the threaded fastener and the surface.

23. The fastener assembly according to claim 21 wherein the threaded fastener comprises a planar base and the cage comprises a bearing surface configured to interface with the base.

24. The fastener assembly according to claim 21 wherein the weldment locations are positioned generally adjacent to the seam.

25. The fastener assembly according to claim 21 wherein a first weldment location is positioned on a first side of the seam and a second weldment location is located on a second side of the seam.
